(19) United States
(12) Patent Application Publication
(10) Pub. No.: US 2015/0033284 A1
(43) Pub. Date: Jan. 29, 2015

(54) DIGITAL MULTIMEDIA BROADCASTING APPARATUS AND METHOD FOR MULTIPLE-DRM SERVICE

(71) Applicant: Electronics and Telecommunications Research Institute, Daejeon (KR)

(72) Inventors: Han Seung KOO, Daejeon (KR); Dong Joon CHOI, Daejeon (KR); Nam Ho HUR, Daejeon (KR); Young Mi SHIN, Suwon-si (KR); Mi Sung CHO, Seoul (KR); Dae Sang YOU, Daejeon (KR); Sung Heun OH, Seoul (KR); Byoung Soo KOH, Suwon-si (KR)

(21) Appl. No.: 14/341,967

(22) Filed: Jul. 28, 2014

(30) Foreign Application Priority Data
Jul. 26, 2013 (KR) 10-2013-0088391
Jul. 17, 2014 (KR) 10-2014-0090543

(51) Int. Cl. H04L 29/06; G06F 21/10

(52) U.S. Cl. CPC H04L 63/10; G06F 21/10; H04L 63/08
USPC 726/1; 726/27; 726/4

(57) ABSTRACT

A method for receiving contents using a mobile terminal according to the present invention is provided. The method includes generating a security channel connected to system being in charge of a service and content protection (SCP) client through an agent downloaded and installed in a mobile terminal; downloading and installing one or multiple SCP client software of different kind from the system through the security channel generated by the agent; and playing back the service or content provided in protected state by a content provider among the one or multiple SCP client software of different kind by driving the decodable SCP client software.

### CROSS-REFERENCE TO RELATED APPLICATION

This application claims priority to Korean Patent Application No. 10-2013-0088391 filed on Jul. 26, 2013, and Korean Patent Application No. 10-2014-0090543 filed on Jul. 17, 2014 the contents of which are herein incorporated by reference in its entirety.

### BACKGROUND OF THE INVENTION

1. Field of the Invention

The present invention relates to a method for providing a digital multimedia broadcasting service and an apparatus utilizing of it, and more particularly, to a digital multimedia broadcasting apparatus and method for multi-DRM services.

2. Discussion of the Related Art

The continuous development of the information and communication industry causes high performance of broadcast receiving terminals and brings about the performance improvement of displays. In particular, due to the high performance of broadcast receiving terminals and continuous growth in technology for displays, the broadcast receiving terminals have been equipped with displays which are available to play images of high definition (HD) level, and recently even better images of full high definition (FHD) level.

However, high definition images which are going to be played by fully utilizing the high definition display of broadcast receiving terminals have not been yet provided by broadcasting stations, regretfully.

In addition, from the point of view of terrestrial broadcasting stations, they have not been fully provided with the benefit of a digital content protection technology. Particularly, it can be said that channels between terrestrial broadcasting stations and broadcast receiving terminals have not been perfectly protected yet.

For this end, a variety of technologies which are called digital rights management (DRM) have been developed recently. The principal object of such various DRM technologies is to restrict the digital contents distributed by a copyright holder being used only for the intended use by a user. However, owing to the development of excessively various DRM technologies, respective terrestrial broadcasting stations have been adopted different DRM technologies, and accordingly, manufacturing companies of the broadcast receiving terminal have a burden to support all sort of DRM technologies. Consequently, in spite of the development of a variety of DRM technologies, it results in a situation that each of terrestrial broadcast stations has not been fully protected in contents.

### SUMMARY OF THE INVENTION

An object of the present invention to solve the problem of described above is to provide a unified content protection method and apparatus in providing digital multimedia broadcasting services.

Another object of the present invention to solve the problem of described above is to provide a content protection method and apparatus through a downloadable authorization apparatus and/or method in providing digital multimedia broadcasting service.

Still another object of the present invention to solve the problem of described above is to provide a method and apparatus for digital multimedia broadcasting services that provide multi-DRM.

According to an aspect of the present invention, a method for receiving contents using a mobile terminal is provided. The method may include generating security channel connected to system being in charge of a service and content protection (SCP) client through an agent downloaded and installed in a mobile terminal; downloading and installing one or multiple SCP client software of different kind from the system through the security channel generated by the agent; and playing back the service or content provided in protected state by a content provider among the one or multiple SCP client software of different kind by driving the decodable SCP client software.

Herein, the agent is an advanced downloadable security environment agent (ADE_agent), the SCP client is a service and content protection client (SCP_client), the system in charge of the service and content protection is a SCP client software policy sub-system (SCS_PSS), generating the security channel is performed by a SCP client software management sub-system (SCS_MSS).

According to another aspect of the present invention, the method for receiving contents using a mobile terminal may include setting up an initial value of the SCP client software installed in the mobile terminal by connecting to a system of the content provider and performing personalization of the SCP client software; and identifying a watching right by connecting to the system in charge of the service and contents client protection of the content provider through the agent.

Herein, in identifying the watching right, the mobile terminal identifies the watching right is performed by identifying hardware capability, in identifying the watching right.

Herein, identifying the watching right is performed by receiving a watching right confirmation response from the content provider through the agent.

Herein, the watching right confirmation response is included in contents received from the content provider.

Herein, setting up the initial value of the SCP client software installed and performing personalization of the SCP client software is performed by a SCP client software initialization personalization sub-system (SCS_ISS).

Herein, in generating the security channel, the agent is installed in the mobile terminal beforehand by a mobile terminal manufacturer.

Herein, in downloading and installing one or multiple SCP client software, the mobile terminal connects to the content provider, and downloads the SCP client software which is differentiated according to a user authority.

The method for receiving contents using a mobile terminal may further include if an apparatus for managing a security environment which is downloadable exists, loading the agent from the apparatus for managing a security environment which is downloadable by connecting to the system for managing the agent, and wherein the agent loaded by loading the agent is used in generating the security channel.

Herein, the apparatus for managing a security environment which is downloadable is an advanced downloadable security environment management (ADEM) apparatus, and the system for managing the agent is an advanced downloadable security environment management sub-system (ADE_MSS).

According to yet another aspect of the present invention, a method for managing downloadable security environment performed by an apparatus for managing downloadable security environment is provided. The method may include receiving a download request of an agent that provides downloadable security environment form a mobile terminal; performing authorization of the mobile terminal using authorization identifier information which is included in the download request of the agent; generating a security channel with the mobile terminal if the authorization identifier information matches as a result of performing the authorization of the mobile terminal; and transmitting the agent to the mobile terminal using the security channel.

Herein, the agent is an advanced downloadable security environment agent (ADE_agent), and wherein the apparatus for managing downloadable security environment is an advanced downloadable security environment management apparatus.

Herein, in generating the security channel, the security channel provides message authorization for the agent, confidentiality and integrity.

Herein, in receiving the download request of an agent, the download request of an agent comprises at least one of information of the mobile terminal, authorization identifier information of the mobile terminal and authorization key information of the mobile terminal.

According to yet another aspect of the present invention, an apparatus for managing downloadable security environment is provided. The apparatus may perform receiving a download request of an agent that provides downloadable security environment form a mobile terminal, performing authorization of the mobile terminal using authentication identifier information which is included in the download request of the agent, generating a security channel with the mobile terminal if the authorization identifier information matches as a result of performing the authorization of the mobile terminal, and transmitting the agent to the mobile terminal using the security channel.

Herein, the agent is an advanced downloadable security environment agent (ADE_agent), and wherein the apparatus for managing downloadable security environment is an advanced downloadable security environment management apparatus.

Herein, the security channel provides an application of the mobile terminal, downloadable message authorization for the agent, confidentiality and integrity.

Herein, the download request of an agent comprises at least one of information of the mobile terminal, authorization identifier information of the mobile terminal and authorization key information of the mobile terminal.

### ADVANTAGEOUS EFFECTS

As described above, the present invention provides a unified content protection method and apparatus in providing digital multimedia broadcasting services.

The present invention provides a content protection method and apparatus through a downloadable authorization apparatus and/or method in providing digital multimedia broadcasting service.

The present invention provides a method and apparatus for digital multimedia broadcasting services that provide multi-DRM.

### BRIEF DESCRIPTION OF THE DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a conceptual diagram of digital rights management (DRM).

FIG. 2 is a drawing schematically illustrating the service and content protection (SCP).

FIG. 3 is a block diagram illustrating the configuration according to an embodiment of a unified content protection technology in case that a 3^{rd} party does not exist.

FIG. 4 is a block diagram illustrating the configuration according to an embodiment of a unified content protection technology in case that a 3^{rd} party authentication apparatus exists.

FIG. 5 is a drawing comparing the actors and the roles assigned to the actors according to the presence of an advanced downloadable security environment management (ADEM) apparatus.

FIG. 6 is a block diagram illustrating the content receiving technology using a mobile terminal in case that an advanced downloadable security environment management (ADEM) apparatus does not exist.

FIG. 7 is a block diagram illustrating a content receiving technology using a mobile terminal if an advanced downloadable security environment management (ADEM) apparatus exists.

FIG. 8 is a drawing illustrating the process of ADE_agent download of a mobile terminal and performing personalization, if an ADEM apparatus exists.

FIG. 9 is a drawing illustrating the personalization performing procedure of the ADE_agent, if the ADEM apparatus does not exist.

FIG. 10 is a drawing illustrating the SCP-client download of the mobile terminal and the installation procedure thereof.

FIG. 11 is a drawing illustrating the procedure of contents watching operation of the mobile terminal.

FIG. 12 is a flow chart of the content receiving method using the mobile terminal according to an embodiment of the present invention.

FIG. 13 is a flow chart of the content receiving method using the mobile terminal according to an embodiment of the present invention, which is the case that the ADEM apparatus exists.

### DETAILED DESCRIPTION OF THE INVENTION

The inventive subject matter now will be described more fully hereinafter by reference to the accompanying drawings, in which embodiments of the present invention are shown. In describing embodiments of the present invention, if the detailed description for the related known elements or functions may depart from the subject matter of the present invention, the detailed description may be omitted.

It will be understood that when an element is referred to as being “connected” or “accessed” to another element, it can be directly connected or got accessed to the other element or intervening elements may be exist. It will be further understood that a specific element is referred to as being “include” does not mean the exclusion of the element which is not included in the corresponding features, but additional elements may be included in the scope of the embodiment of the present invention or the technical principles of the present invention.

It will be understood that, although the terms first, second, etc. may be used herein to describe various elements, the above elements should not be limited by these terms. These terms are only used to distinguish one element from another. For example, a first element can be termed a second element, and similarly, a second element can be termed a first element without departing from the teachings of the present invention.

Also, the elements shown in the embodiments of the present invention are independently illustrated for representing distinctive functions which are different from each other, and do not signify that each of the elements is composed of a unit of separate hardware or a software. That is, each element is included with being recited for the convenience of description, at least two elements may combine to one element, or an element may be divided into plural elements and perform the functions, and the embodiment of the each element combined and the embodiment of the each element divided are included in the scope of the right of the present invention, unless they are diverged from the substance of the present invention.

Also, a part of the elements may be a selective element only for improving the performance, not an essential element performing a substantive function in the present invention. The present invention may be implemented by including essential elements which are indispensible to implement the substance of the present invention excluding the element only for improving the performance, and the structure including only the essential elements excluding selective the element only for improving the performance is also included in the scope of the right of the present invention.

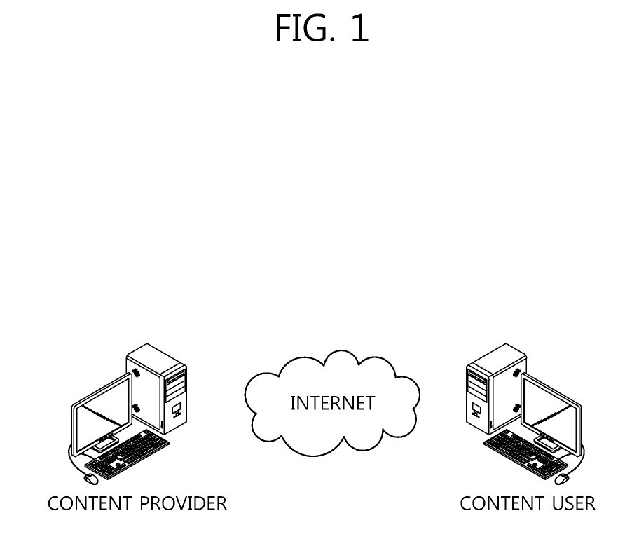

FIG. 1 is a conceptual diagram of digital rights management (DRM).

Referring to FIG. 1, the digital rights management (DRM) may mean the technology that controls the digital contents which are distributed by a manufacturer, a publisher or a copyright holder so as to be used only for intended use. Also, the DRM may mean copy protection, copy prevention or copy control, and also mean the technologies that control hardware in using contents and restrict the contents being used only for the intended use. Lastly, the DRM may mean a content protection technology.

When a non-authenticated user tries to use contents, the DRM may restrict an access to the contents through an authentication, and prevent a non-authenticated user from using the contents through the authentication. In addition, through the DRM authentication, the contents may be controlled not to be leaked outside. Lastly, the DRM may control an authenticated user to use contents only for the authenticated period. As described above, although the DRM technology is concentrated on the protection of contents, the importance of a service protection gets increased as well as that of a content protection, so that the service and content protection (SCP) technology is to be developed.

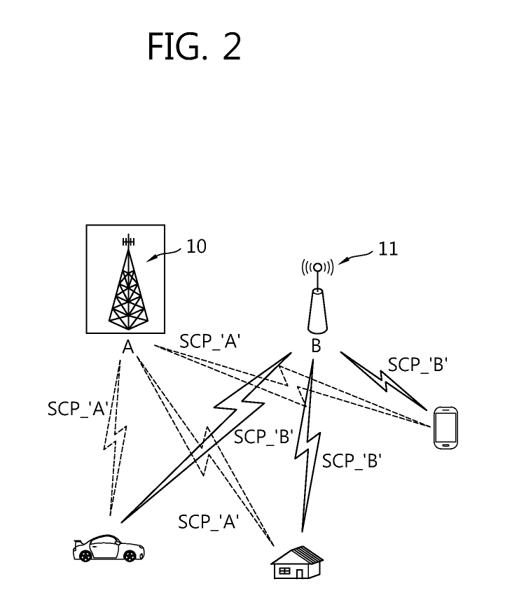

Hereinafter, by reference to FIG. 2, the SCP technology will be briefly described.

FIG. 2 is a drawing schematically illustrating the service and content protection (SCP).

Referring to FIG. 2, the SCP may include a multichannel video program distributor (MVPD) 10 and a terrestrial broadcasting company 11.

A broadcast providing company may include a MVPD and terrestrial broadcasting company, and transmit contents to mobile terminals. In this time, the broadcast providing company may use the content protection technology while providing contents to mobile terminals.

The MVPD 10 or terrestrial broadcasting company 11 may use different content protection technologies for mobile terminals respectively. In this time, the respective content protection technologies for mobile terminals are not configured considering mutual compatibility, but may be provided with a unique technology for each broadcast providing company. In addition, each broadcast providing company may use the content protection technology using a conditional access system (CAS) for pay broadcasting service.

The SCP provides the content protection technology in the aspect of protecting copyright in order to provide broadcasting services for mobile terminals. Particularly, the SCP may provide the content protection technology in order to provide high definition (HD) or full HD (FHD) broadcasting services to mobile terminals.

As reviewed above, different content protection technologies may be used in a mobile terminal platform through the SCP. In this time, the technology that uses different content protection technologies in a mobile terminal platform may mean a multi-DRM service. In addition, the multi-DRM may use different DRM client software for respective DRM solutions.

The MVPD 10 may mean cable TV, satellite broadcast, VOD, MMDS/LMDS (wireless cable TV), IPTV, and so on. In this time, the number of MVPD may be singular or plural, a singular MPVD 10 or a plurality of MVPDs may provide contents to mobile terminals, respectively.

Likewise, the number of terrestrial broadcast companies may be singular or plural, a singular terrestrial broadcasting company 11 or a plurality of terrestrial broadcasting companies 11 may provide contents to mobile terminals, respectively.

Also, the broadcast providing company may use downloadable system for multi-DRM service of mobile broadcasting (DMMB) by using the SCP.

In order to use a SCP client providing the multi-DRM service, safe download and installation of the SCP client are important. Accordingly, it is important to install an advanced downloadable security environment agent (ADE_agent), which provides a security environment that enables a stable download of the SCP client. In this time, the method for installing the ADE_agent in a mobile terminal is divided into the case that a 3^{rd} party authentication apparatus exists and the case that a 3^{rd} part authentication apparatus does not exist.

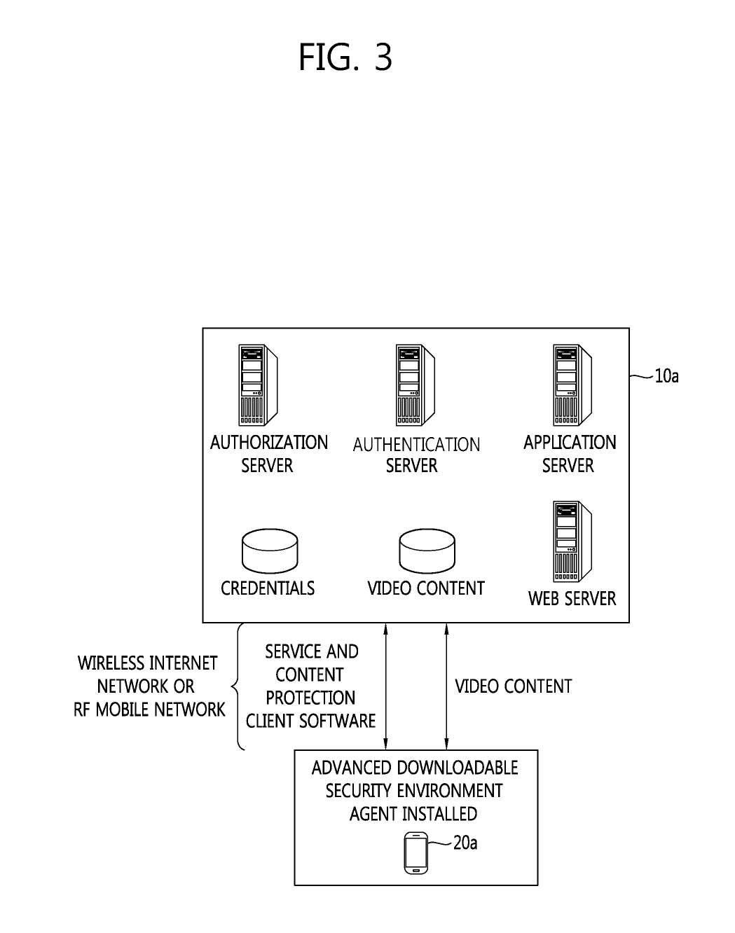

FIG. 3 is a block diagram illustrating the configuration according to an embodiment of a unified content protection technology in case that a 3^{rd} party does not exist.

Referring to FIG. 3, the unified content protection technology includes a content provider 10a and a mobile terminal 20a.

The content provider may include a multichannel video program distributor (MVPD) and a terrestrial broadcasting company.

The content provider 10a may include an authorization server, credentials, an authentication server, an application server, a web server and a video content. In this time, the authorization server and the credential may be operated within a content provider 10a.

The content provider 10a may be connected to a mobile terminal 20a through a network, and connected to the mobile terminal 20a through a wireless internet network. In addition, the content provider 10a may be connected to the mobile terminal 20a through a RF mobile broadcasting network.

The mobile terminal 20a may download a service and content protection client (SCP_client) software through a network. The mobile terminal 20a may install the SCP_client software downloaded in the mobile terminal, and provide pay video contents through the SCP_client software.

In order for the mobile terminal 20a to safely download the SCP_client software from the content provider 10a, an advanced downloadable security environment agent (ADE_agent) should be installed beforehand in the mobile terminal 10a. In this time, the manufacturing company of mobile terminals may install the ADE_agent on manufacturing the mobile terminals. Also, the ADE_agent of a mobile terminal may be directly provided from the content provider 10a, and the mobile terminal 20a may be provided with the ADE_agent through a 3^{rd} party organization that the content provider 10a delegates.

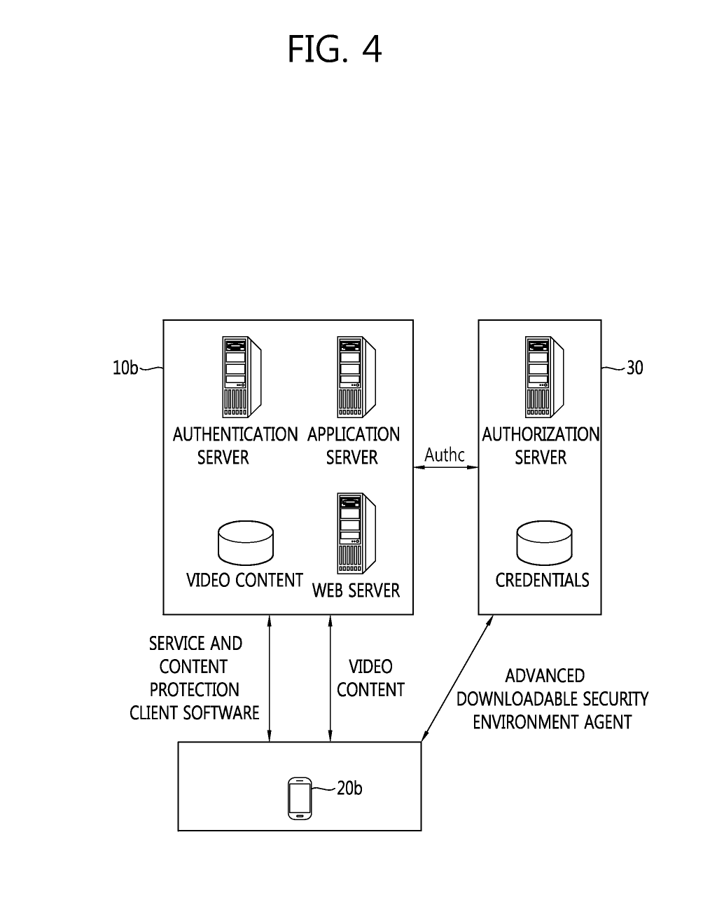

FIG. 4 is a block diagram illustrating the configuration according to an embodiment of a unified content protection technology in case that a 3^{rd} party authorization apparatus exists.

Referring to FIG. 4, the unified content protection technology includes a content provider 10b, a 3^{rd} party authorization apparatus 30 and a mobile terminal 20b.

The content provider may include a multichannel video program distributor (MVPD) and a terrestrial broadcasting company.

The content provider 10b may include an authentication server, an application server, a web server and a video content.

The content provider 10b may be connected to the mobile terminal 20b through a network, and connected to the mobile terminal 20b through a wireless internet network. In addition, the content provider 10b may be connected to the mobile terminal 20b through a RF mobile broadcasting network.

The 3^{rd} party authorization apparatus 30 may include an authorization server and a credential.

The 3^{rd} party authorization apparatus 30 determines whether the request is available to install an advanced downloadable security environment agent (hereinafter, ADE-agent) of the mobile terminal 20b by using the authorization server and credential. If the request for installing the ADE_agent of the mobile terminal is valid, the 3^{rd} party authorization apparatus 30 may transmit the ADE_agent to the mobile terminal through a network, the 3^{rd} party authorization apparatus 30 may transmit the ADE_agent to the mobile terminal through a wireless internet network, and the 3^{rd} party authorization apparatus 30 may transmit the ADE_agent to the mobile terminal through a RF mobile broadcasting network instead of an internet network. Lastly, the 3^{rd} party authorization apparatus 30 may install the ADE_agent in the mobile terminal in the offline state.

If the ADE_agent is installed in a mobile terminal in the offline state as described above, the ADE_agent may be installed in the mobile terminal by a content provider, a MVPD, a terrestrial broadcasting company, a 3^{rd} party organization that is delegated to install the ADE_agent by a content provider or a 3^{rd} party organization that is delegated to install ADE_agent by a terrestrial broadcasting company.

If the 3^{rd} party authorization apparatus 30 transmits the ADE_agent to a mobile terminal through a network, a wireless internet network or a RF mobile broadcasting network, a predefined communication protocol method may be used between the 3^{rd} party authorization apparatus 30 and the mobile terminal. In this time, while the 3^{rd} party authorization apparatus 30 transmits the ADE_agent to the mobile terminal, a security method may be provided in order for the predefined communication protocol, the 3^{rd} party authorization apparatus information, and the mobile terminal information not to be hacked.

In this time, the 3^{rd} party authorization apparatus 30 may be defined as an advanced downloadable security environment management (ADEM) apparatus.

The mobile terminal 20b may download a service and content protection client (SCP_client) software through a network. The mobile terminal 20b may install the downloaded SCP_client software in the mobile terminal, and provide pay video content through the SCP_client software.

In order for the mobile terminal 20b to safely download the SCP_client software from the content provider 10b, the ADE_agent should be installed in the mobile terminal through the process of installing the ADE_agent described above.

Hereinafter, by separating the cases into that a 3^{rd} party authorization apparatus exists or that a 3^{rd} party authorization apparatus does not exist, the respective actors and the roles assigned to the actors will be described in detail.

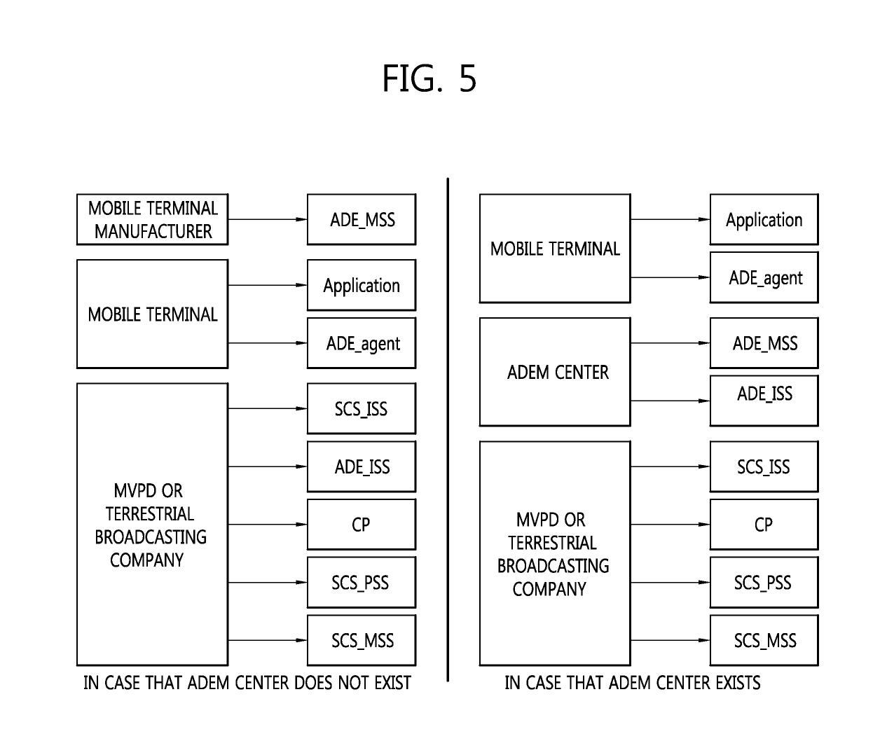

FIG. 5 is a drawing comparing the actors and the roles assigned to the actors according to the presence of an advanced downloadable security environment management (ADEM) apparatus.

Referring to FIG. 5, if the ADEM apparatus does not exist, the actor includes a mobile terminal manufacturer, a mobile terminal, a multichannel video program distributor (MVPD) or a terrestrial broadcasting company.

The SCP may provide a downloadable system for multi-DRM service of mobile broadcasting (DMMB) from a service provider (SP). In addition, the SCP may provide a single sign on (SSO) that makes resources of multiple computers usable by one authentication. In this time, a user may perform a content protection access with only one ID and password using the SSO.

In order to implement the service and content protection (SCP), the mobile terminal manufacturer may include an advanced downloadable security environment management sub-system (ADE_MSS). Also, if the advanced downloadable security environment management (ADEM) apparatus does not exist, the advanced downloadable security environment agent (ADE_agent) may be installed in a mobile terminal by the mobile terminal manufacturer through the ADE_MSS.

If the ADEM apparatus does not exist, the mobile terminal may include an application and an ADE_agent. In this time, the operation of the ADE_agent is as described above.

If the ADEM apparatus does not exist, the multichannel video program distributor (MVPD) or the terrestrial broadcasting company may include a SCP client software Initialization personalization sub-system (SCS_ISS), an advanced downloadable security environment initialization personalization sub-system (ADE_ISS), a content provider (CP), a SCP client software policy sub-system (SCS_PSS) and a SCP client software management sub-system (SCS_MSS).

If the ADEM apparatus does not exist, the SCS_ISS may perform a SCP_client software personalization operation. The ADE_ISS may perform an ADE personalization function. The CP performs the function of providing a content list to the mobile terminal. In this time, even before the SCP_client software is installed in the mobile terminal, the mobile terminal may see the content list. Also, the CP performs a content repository function, and a video streaming management function. The SCS_PSS may provide a differentiated function of downloading the SCP_client software according to the watching permission level of viewers. In addition, the SCS_PSS may provide a SCP_client software management function according to the difference of hardware capability of a mobile terminal. In this time, the ADEM apparatus may mean an ADEM apparatus or the method thereof.

The SCS_MSS may perform the security channel forming function between the SCS_MSS and the ADE_agent inside of the mobile terminal. Additionally, the SCS_MSS may perform the function of transmitting the SCP_client software to the mobile terminal, and perform the function as a repository of the SCP_client software.

Referring to FIG. 5, if the ADEM apparatus exists, the actor includes a mobile terminal, an ADEM apparatus, a MVPD or a terrestrial broadcasting company.

In this time, the mobile terminal may include an application and the ADE_agent. Here, the operation of the ADE_agent is as described above.

If the ADEM apparatus exists, the ADEM apparatus may include an ADE_MSS and an ADE_ISS. The ADE_MSS may provide the transmission management function of ADE_agent using a network. Also, the ADE_MSS may install the ADE_agent in the mobile terminal in the offline state. The ADE_ISS may perform the ADE personalization function. The SCS_ISS may perform the SCP_client software personalization operation. Further, the ADE_ISS may perform the ADE personalization function. The CP performs the function of providing a content list to the mobile terminal. In this time, even before the SCP_client software is installed in the mobile terminal, the mobile terminal may see the content list. Also, the CP performs the content repository function, and performs the video streaming management function. In addition, the SCS_PSS may provide the differentiated downloading function of the SCP_client according to the watching permission level of viewers. Further, the SCS_PSS may provide the SCP_client software management function according to the difference of hardware capability of the mobile terminal. The SCS_MSS may perform the security channel forming function between the SCS_MSS and the ADE_agent inside of the mobile terminal. Additionally, the SCS_MSS may perform the function of transmitting the SCP_client software to the mobile terminal, and perform the function as a repository of the SCP_client software.

The MVPD described above may imply a content provider and be replaced by a terrestrial broadcasting company. Also, the ADEM apparatus may imply a 3^{rd} party authorization apparatus.

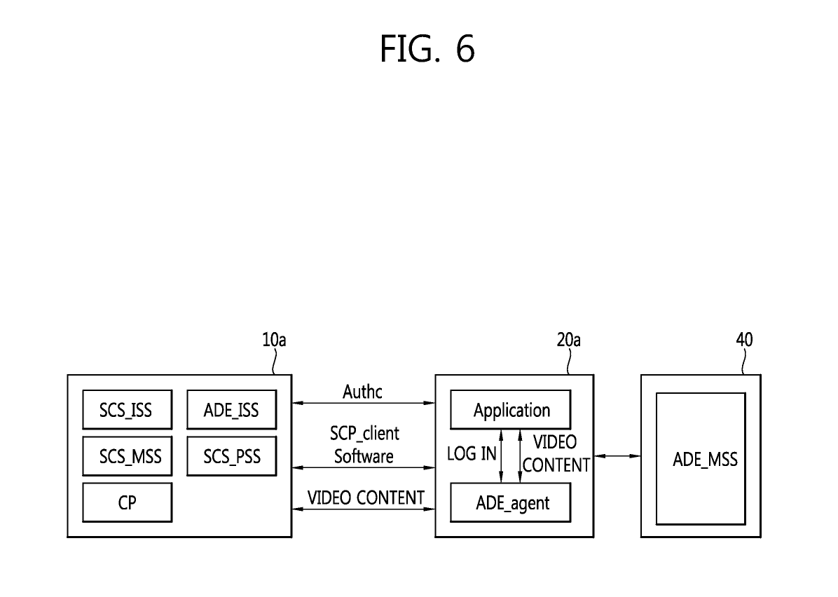

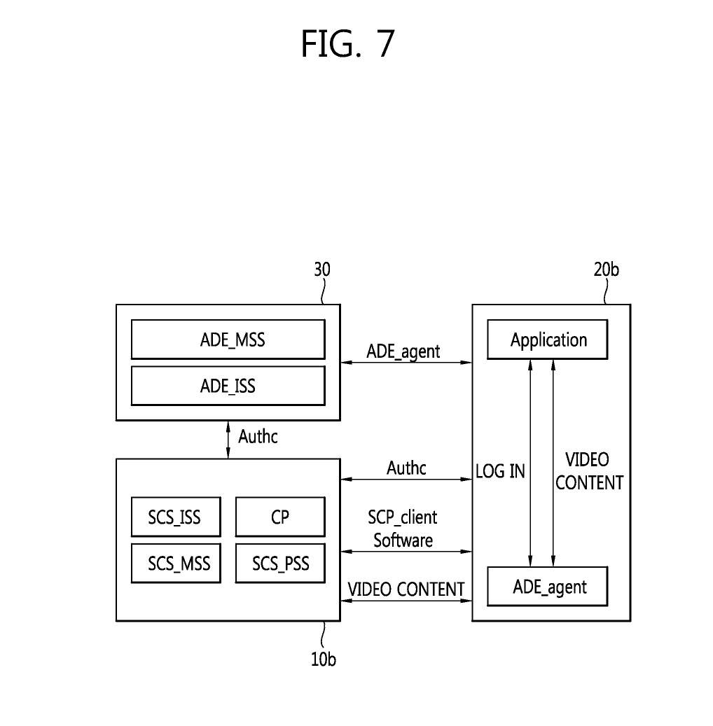

Hereinafter, based on the actor in FIG. 5 and the role which is allocated on each actor, a content receiving technology using the mobile terminal will be described in FIG. 6 and FIG. 7.

FIG. 6 is a block diagram illustrating the content receiving technology using a mobile terminal in case that an advanced downloadable security environment management (ADEM) apparatus does not exist.

Referring to FIG. 6, the content receiving technology using the mobile terminal includes a content provider 10a, a mobile terminal 20a, and a mobile terminal manufacturer 40.

The content provider may include a multichannel video program distributor (MVPD) 10a and a terrestrial broadcasting company.

The content provider 10a may include SCS_ISS, ADE_ISS, SCS_MSS, SCS_PSS, and CP. In this time, the functions of the SCS_ISS, ADE_ISS, SCS_MSS, SCS_PSS, and CP are same as the case that the ADEM apparatus does not exist as described in FIG. 5 above.

The mobile terminal 20a may include an application and an ADE_agent. In this time, the operation of the ADE_agent is same as described above.

The mobile terminal 20a may perform the ADE log in by connecting the SCS_PSS of the content provider 10a through the ADE_agent. In this time, the ADE_agent is installed when the mobile terminal 20a is manufactured by the mobile terminal manufacturer 40. Accordingly, the address of SCS_PSS may be obtained by the proxy of the mobile terminal manufacturer. Also, the address of SCS_PSS may be obtained by the proxy of the ADE_agent manufacturer.

The mobile terminal 20a may browse the content by connecting the content provider (CP) 10a through the ADE_agent. In this time, the CP address may be obtained by the proxy of the mobile terminal manufacturer. Also, the CP address may be obtained by the proxy of the ADE_agent manufacturer.

The mobile terminal 20a may connect the SCS_MSS of the content provider 10a which performs the security channel forming function between the content provider 10a and the mobile terminal 20a, download a SCP_client software and install the SCP_client software in the mobile terminal. When downloading the SCP_client software and installing it in itself, the mobile terminal may download the differentiated SCP_client software according to the user's authority by connecting to the SCS_PSS. In this time, the license of the SCP_client may include in the SCP_client. Additionally, the license of the SCP_client may be provided for the mobile terminal separately from the SCP_client.

The mobile terminal 20a may perform the SCP_client personalization by connecting to the SCS_ISS of the content provider 10a which perform the personalization operation of the SCP_client software.

Lastly, the mobile terminal 20a may check the watching right by connecting to the SCS_PSS of the content provider through the ADE_agent. In this time, the mobile terminal may receive the watching right confirmation response from the content provider 10a through the ADE_agent. Also, considering the security aspect of the watching right acquisition, the mobile terminal 20a may receive the watching right confirmation response with the response being included in the content stream from the CP of the content provider 10a through the ADE_agent.

The mobile terminal manufacturer 40 may install the ADE_agent in the mobile terminal through the ADE_MSS.

The ADEM apparatus may mean a 3^{rd} party authorization apparatus.

A method for receiving contents using a mobile terminal according to an embodiment of the present invention may include generating a system and security channel which is in charge of the service and content protection (SCP) client through the agent downloaded and installed in the mobile terminal; downloading and installing one or multiple SCP client software of different kinds from the system through the security channel generated by the agent; playing back the service or content provided in protected state by a content provider among the one or multiple SCP client software of different kinds by driving the decodable SCP client software.

In the method for receiving contents using a mobile terminal, the agent is an advanced downloadable security environment agent (ADE_agent), the SCP client is a service and content protection client (SCP_client), the system in charge of the service and content protection is a SCP client software policy sub-system (SCS_PSS), generating the security channel is performed by a SCP client software management sub-system (SCS_MSS). In this time, the operation of each element is as described above.

A method for receiving contents using a mobile terminal according to another embodiment of the present invention may include setting up an initial value of the SCP client software installed in the mobile terminal by connecting to a system of the content provider and performing personalization of the SCP client software; and identifying a watching right by connecting to the system in charge of the service and contents client protection of the content provider through the agent.

In the method for receiving contents using a mobile terminal, setting up the initial value of the SCP client software installed and performing personalization of the SCP client software is performed by a SCP client software initialization personalization sub-system (SCS_ISS). In this time, the operation of each element is as described above.

FIG. 7 is a block diagram illustrating a content receiving technology using a mobile terminal if an advanced downloadable security environment management (ADEM) apparatus exists.

Referring to FIG. 7, the contents receiving technology using a mobile terminal includes an ADEM apparatus 30, a content provider 10b and a mobile terminal 20b.

The content provider may include a MVPD and a terrestrial broadcasting company.

The ADEM apparatus 30 may include an ADE_MSS and an ADE_ISS. In this time, the functions of the ADE_MSS and the ADE_ISS are the same as the case that the ADEM apparatus of FIG. 5 exists.

The mobile terminal may include an application and an ADE_agent.

The mobile terminal 20b may connect to the ADE_MSS of the ADEM apparatus 30, and load the ADE_agent through the ADEM apparatus 30.

The mobile terminal 20b may connect to a SCS_PSS of the content provider 10b through the ADE_agent, and ADE log in. In this time, the address of the SCS_PSS may be obtained through the ADEM apparatus.

The mobile terminal 20b may connect to a content provider (CP) 10b through the ADE_agent, and perform content browsing. In this time, the address of the CP may be obtained through the ADEM apparatus.

The mobile terminal 20b may connect to the SCS_MSS of the content provider 10b that performs a security channel forming function between the content provider 10b and the mobile terminal 20b, download SCP_client software and install the SCP_client software in the mobile terminal. When downloading SCP_client software and installing the SCP_client software in the mobile terminal, the mobile terminal may connect to the SCS_PSS and download the SCP_client software which is differentiated according to user authority. In this time, the license of the SCP_client may be included in the SCP_client. Also, the license of the SCP_client may be provided to the mobile terminal apart from the SCP_client.

The mobile terminal 20b may connect to the SCS_ISS of the content provider that performs the personalization operation of the SCP_client software, and perform the SCP_client personalization.

Lastly, the mobile terminal 20a may check the watching right by connecting to the SCS_PSS of the content provider through the ADE_agent. In this time, the mobile terminal may receive a watching right confirmation response from the content provider 10a through the ADE_agent. Also, considering the security aspect of the watching right acquisition, the mobile terminal 20a may receive the watching right confirmation response with the response being included in the content stream from the CP of the content provider 10a through the ADE_agent.

The ADEM apparatus may mean a 3^{rd} party authorization apparatus.

A method for receiving contents using a mobile terminal according to an embodiment of the present invention may include generating a system and security channel being in charge of a service and content protection (SCP) client through an agent downloaded and installed in a mobile terminal; downloading and installing one or multiple SCP client software of different kind from the system through the security channel generated by the agent; playing back the service or content provided in protected state by a content provider among the one or multiple SCP client software of different kind by driving the decodable SCP client software.

In the method for receiving contents using a mobile terminal, the agent is an advanced downloadable security environment agent (ADE_agent), the SCP client is a service and content protection client (SCP_client), the system in charge of the service and content protection is a SCP client software policy sub-system (SCS_PSS), generating the security channel is performed by a SCP client software management sub-system (SCS_MSS). In this time, the operation of each element is as described above.

A method for receiving contents using a mobile terminal according to another embodiment of the present invention may include setting up an initial value of the SCP client software installed in the mobile terminal by connecting to a system of the content provider and performing personalization of the SCP client software; and identifying a watching right by connecting to the system in charge of the service and contents client protection of the content provider through the agent.

In the method for receiving contents using a mobile terminal, setting up the initial value of the SCP client software installed and performing personalization of the SCP client software is performed by a SCP client software initialization personalization sub-system (SCS_ISS). In this time, the operation of each element is as described above.

The method for receiving contents using a mobile terminal, if a apparatus for managing a security environment which is downloadable exists, further includes loading the agent from the apparatus for managing a security environment which is downloadable by connecting to the system for managing the agent, and the agent loaded by loading the agent is used in generating the security channel.

In the method for receiving contents using a mobile terminal, the apparatus for managing a security environment which is downloadable is an advanced downloadable security environment management (ADEM) apparatus, and the system for managing the agent is an advanced downloadable security environment management sub-system (ADE_MSS). In this time, the operation of each element is as described above.

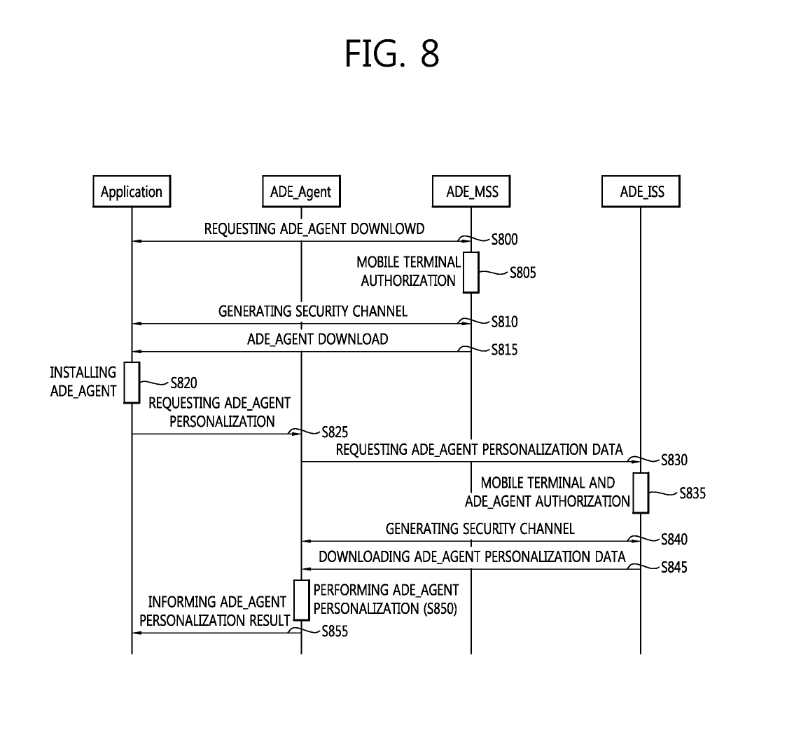

FIG. 8 is a drawing illustrating the process of ADE_agent download of a mobile terminal and performing personalization, if an ADEM apparatus exists.

According to an embodiment of the present invention, the application of a mobile terminal detects that the ADE_agent is not installed in the mobile terminal, and transmits ADE_agent download request message to the ADE_MSS of the ADEM apparatus (step, S800). In this time, the location information of the ADE_MSS may be configured in the mobile terminal beforehand. Also, the location information of the ADE_MSS may be configured in the application beforehand. When the mobile terminal transmits the download request message, authorization identifier information, authorization key information and/or mobile terminal information may be transmitted.

When the ADE_MSS completes the mobile terminal authorization, the mobile terminal generates a security channel between the application of the mobile terminal and the ADE_MSS of the ADEM in order to perform safe download of the ADE_agent (step, S810). In this time, the security channel provides the entity authorization for the application of the mobile terminal and the ADE_MSS of the ADEM, the message authorization for the AGE_agent which is downloaded, confidentiality and/or integrity.

After forming the security channel between the application of the mobile terminal and the ADE_agent of the ADEM apparatus, the application of the mobile terminal downloads the ADE_agent from the ADE_MSS (step, S815). In this time, the location information of the ADE_ISS may receive as well on downloading the ADE_agent. Also, the ADE_agent may include the ADE_ISS.

After that, the application of the mobile terminal installs the ADE_agent in the mobile terminal (step, S820).

After installation of the ADE_agent, the application of the mobile terminal requests the ADE_agent of the mobile terminal to perform personalization (step, S825).

If the ADE_agent of the mobile terminal receives a request for the personalization from the application of the mobile terminal, the ADE_agent transmits a personalization data request message to the ADE_ISS of the ADEM apparatus in order to perform the personalization (step, S830). In this time, the personalization data request message may include the information of the mobile terminal, the authorization identifier information which is provided from the application, the authorization key information which is provided by the application, the information of the ADE_agent installed.

If the ADE_ISS has completed the authorization of the mobile terminal and the ADE_agent, the mobile terminal application generates a security channel between the ADE_ISSs of ADEM (step, S840). In this time, the security channel provides the entity authorization for the application of the mobile terminal and the ADE_agent of ADEM, the message authorization for the downloadable ADE_agent, and confidentiality and/or integrity.

The ADE_agent of the mobile terminal receives the ADE_agent personalization data from the ADE_ISS by using a security channel (step, S845). In this time, the ADE_agent personalization data may include the ADE_agent identifier and ADE_agent authorization certificate.

The ADE_agent of the mobile terminal which receives the personalization data performs the personalization by using the downloaded personalization data (step, S850).

After that, the ADE_agent of the mobile terminal informs the personalization result to the application of the mobile terminal (step, S855).

According to another embodiment of the present invention, the advanced downloadable security environment management sub-system (ADE_MSS) of the ADEM apparatus receives a request for the ADE_agent downloading from the mobile terminal (step, S800).

In this time, the ADE_MSS of the ADEM apparatus performs the mobile terminal authorization using the authorization identifier information which is included in the ADE_agent download request (step, S805). In this time, the authorization key which is included in ADE_agent download request may be used instead of the authorization identifier which is included in ADE_agent download request.

By the result of performing the mobile terminal authorization, if the authorization identifier information is identical, the ADE_agent of the ADEM apparatus generates the security channel between the mobile terminal and the ADE_MSS of ADEM (step, S810).

The ADE_MSS of ADEM transmits the ADE_agent which is suitable for the mobile terminal by using the security channel (step, S815).

The ADE_ISS of ADEM receives an ADE_agent personalization data request message from the mobile terminal (step, S830).

In this time, the ADE_ISS of ADEM performs the mobile terminal authorization by using the authorization identifier information included in the personal data request message and the ADE_agent information (step, S835).

By the result of performing the mobile terminal authorization, if the authorization identifier information is identical, the ADE_ISS generates a security channel between the mobile terminal and the ADE_ISS of ADEM (step, S840).

The ADE_ISS of ADEM transmits the ADE_agent personalization data which is suitable for the mobile terminal by using a security channel (step, S845).

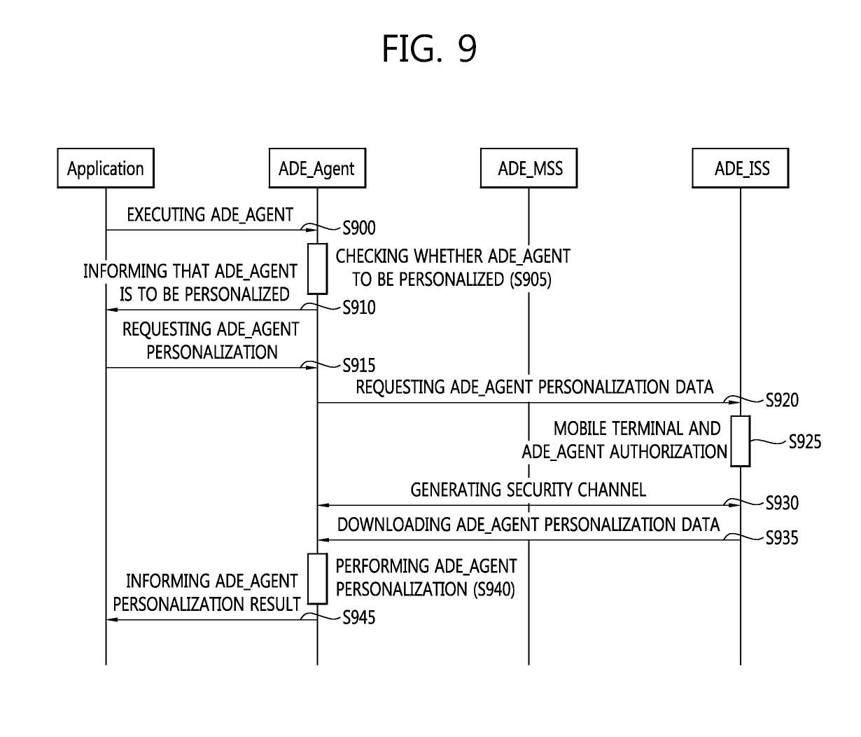

FIG. 9 is a drawing illustrating the personalization performing procedure of the ADE_agent, if the ADEM apparatus does not exist.

The application of the mobile terminal executes the ADE_agent of the mobile terminal previously installed (step, S900).

The ADE_agent of the mobile terminal checks whether the ADE_agent to be personalized (step, S905). In this time, if the ADE_agent is turned to be personalized by the result of checking whether the ADE_agent is necessary to be personalized, the procedure of the ADE_agent personalization is stopped.

If the ADE_Agent is necessary to be personalized, the ADE_agent of the mobile terminal informs the need of personalization to an application (step, S910).

If the application receives the requirement of the personalization, the mobile terminal application requests to implement personalization to the mobile terminal Ade_agent (step, S915).

If the ADE_Agent of the mobile terminal receives the request of personalization from the application of the mobile terminal, the ADE_agent transmits the personalization data request message to the ADE_ISS of the ADEM apparatus in order to perform the personalization (step, S920). In this time, the personalization data request message may include the mobile terminal information, the authorization identifier information which is provided from an application, the authorization key information which is provided from an application, and the ADE_Agent information installed.

If the ADE_ISS has completed the authorization of the mobile terminal and the ADE_agent, the mobile terminal application generates a security channel between the ADE_ISSs of ADEM (step, S930). In this time, the security channel provides the entity authorization for the application of the mobile terminal and the ADE_agent of ADEM, the message authorization for the downloadable ADE_agent, and confidentiality and/or integrity.

The ADE_agent of the mobile terminal receives the ADE_agent personalization data from the ADE_ISS by using a security channel (step, S935). In this time, the ADE_agent personalization data may include the ADE_agent identifier and ADE_agent authorization certificate.

The ADE_agent of the mobile terminal which receives the personalization data performs the personalization by using the downloaded personalization data (step, S940).

After that, the Ade_agent of the mobile terminal informs the personalization result to the application of the mobile terminal (step, S945).

According to another embodiment of the present invention, the ADE_ISS of a content provider receives the ADE_agent personalization data request from the mobile terminal (step, S920).

In this time, the ADE_ISS of the content provider performs the mobile terminal authorization by using the authorization identifier information included in the personalization data request message and the ADE_agent information (step, S925).

By the result of performing the mobile terminal authorization, if the authorization identifier information is identical, the ADE_ISS of a content provider generates a security channel between the mobile terminal and the ADE_ISS of the content provider (step, S930).

The ADE_agent of the content provider transmits the ADE_agent personalization date which is suitable for the mobile terminal by using the security channel (step, S935).

In this time, the content provider may be replaced by a terrestrial broadcasting company.

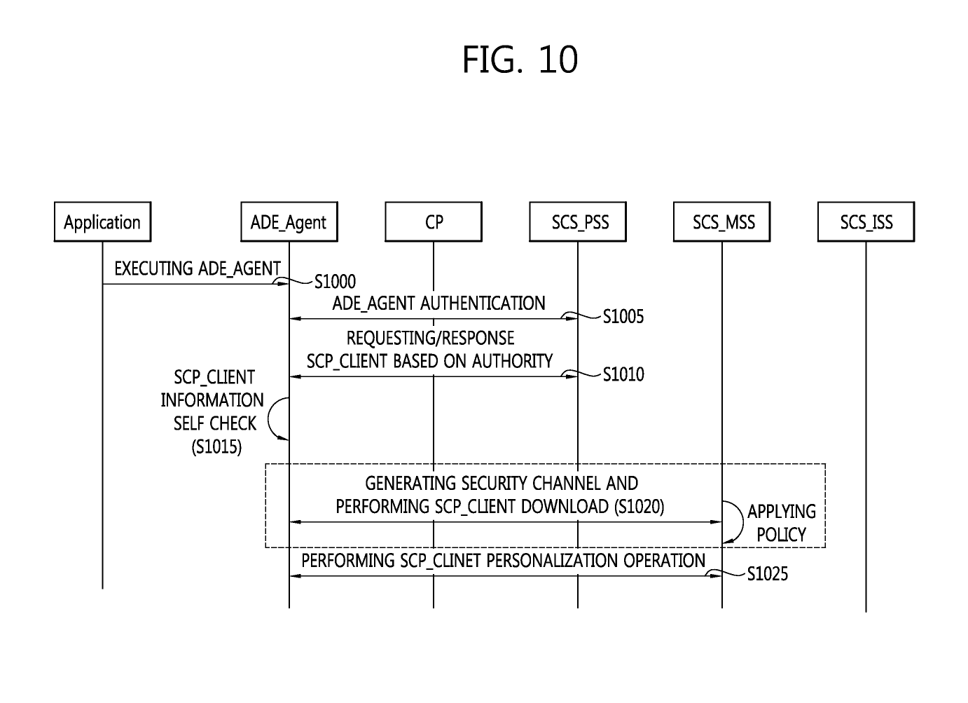

FIG. 10 is a drawing illustrating the SCP-client download of the mobile terminal and the installation procedure thereof.

Referring to FIG. 10, the application of the mobile terminal executes the ADE_agent of the mobile terminal before downloading the SCP_client (step, S1000).

The ADE_agent of the mobile terminal requests the ADE_agent authorization to the SCS_PSS of a content provider (step, S1005). When requesting the authorization of the ADE_agent, the information acquired through the ADE_agent personalization is utilized.

The ADE_agent of the mobile terminal requests the information of the SCP client to the SCS_PSS of a content provider and receives the downloadable SCP client information through the authority information from the SCS_PSS of the content provider (step, S1010).

The ADE_agent of the mobile terminal performs a self-check of the presence of the corresponding SCP client's download in the mobile terminal based on the SCP client information which is received from the SCS_PSS of a content provider (step, S1015).

If there is no SCP client in the mobile terminal or there is a necessity to upgrade the SCP client, the ADE_agent of the mobile terminal forms a security channel with the SCS_MSS of a content provider, and downloads the SCP client through the security channel (step, S1020).

The ADE_agent of the mobile terminal implements the downloaded SCP client and performs the SCP client personalization operation through the SCS_ISS of a content provider (step, S1025).

The procedure of downloading and installation of the mobile terminal may carry out after the procedure of ADE_agent downloading and installation. Also, after the procedure of the SCP client downloading and installation of the mobile terminal, the mobile terminal may implement contents watching operation.

In this time, a content provider may be replaced by a terrestrial broadcasting company.

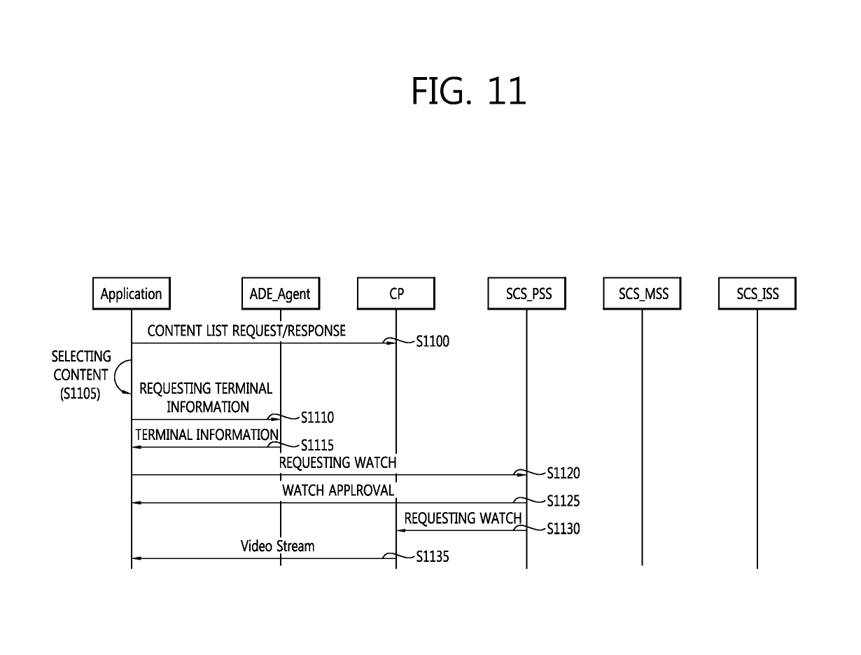

FIG. 11 is a drawing illustrating the procedure of contents watching operation of the mobile terminal.

Referring to FIG. 11, the application of the mobile terminal requests a content list to the CP of a content provider and receives the result (S1100). The procedure of requesting a content list and receiving the result may be performed before the downloading of the SCP_client depending on the application of the mobile terminal.

The application of the mobile terminal selects contents in the content list which is received from the CP of the content provider (step, S1105). The application may provide the content list to a user of the mobile terminal, and receive the content selecting information from the mobile terminal user. In this time, the content list may vary depending on the mobile terminal application and/or the authority of the ADE_agent.

The application of the mobile terminal asks the ADE_agent of the mobile terminal for the information of the mobile terminal (step, S1110). In this time, the information of the mobile terminal may include the content buffering information. Also, the information of the mobile terminal may include the information of hardware performance of the mobile terminal. The information of hardware performance of the mobile terminal may include the information which may influence on watching contents.

The application of the mobile terminal receives the information of the mobile terminal from the ADE_agent of the mobile terminal (step, S1115).

Then, the application of the mobile terminal requests to watch for the selected content from the SPS_PSS of the content provider (step, S1120).

After that, the application of the mobile terminal receives a message of the approval for watching from the SCS_PSS of the content provider (step, S1125).

If the CP of the content provider receives a request for watching from the SCS_PSS, the application of the mobile terminal receives the video stream of the content selected from the CP of the content provider (step, S1135).

According to another embodiment of the present invention, the CP of the content provider receives the information of requesting the content list from the application of the mobile, and transmits the content list to the application (step, S1100).

After that, the SCS_PSS of the content provider receives a request for watching contents from the application (step, S1120).

The SCS_PSS of the content provider checks the hardware capability of the mobile terminal, and transmits a message of the approval for watching to the mobile terminal (step, S1125).

Additionally, the SCS_PSS of the content provider, if the content selected is available to watch, transmits a request for watching to the CP of the content provider (step, S1130).

The content watching operation procedure of the mobile terminal may be implemented after the downloading and installation of the ADE_agent. Also, the content watching operation procedure of the mobile terminal may be implemented after the downloading and installation of the SCP_client.

In this time, the content provider may be replaced by a terrestrial broadcasting company, and in that case of being replaced, the concrete way of operation is the same as that of the content provider described above.

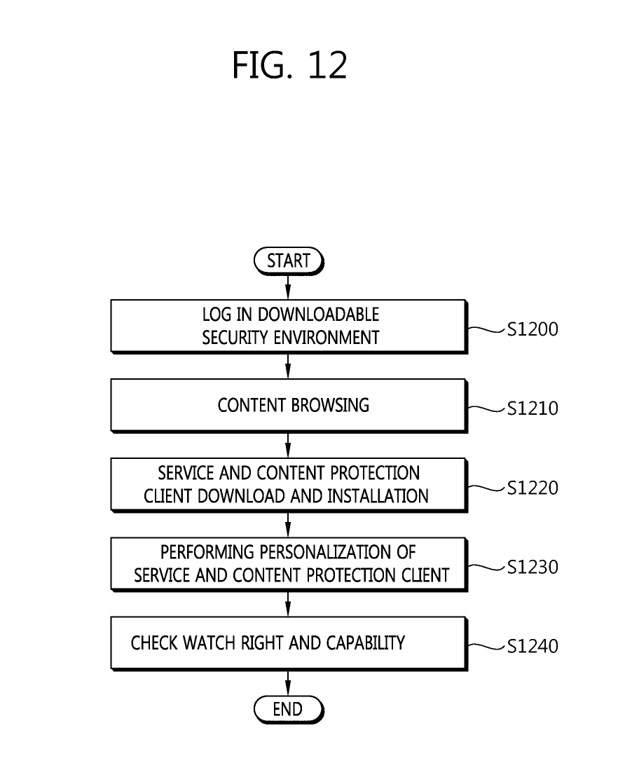

FIG. 12 is a flow chart of the content receiving method using the mobile terminal according to an embodiment of the present invention.

Referring to FIG. 12, the ADE_agent of the mobile terminal performs the ADE log in by connecting to the SCS_PSS of the central processing unit (step, S1200). In this time, the concrete way of ADE log in is the same as described in FIG. 6 and/or FIG. 7 above.

The ADE_agent of the mobile terminal performs the content browsing by connecting to the CP of the central processing unit (step, S1210). In this time, the concrete way of content browsing is the same as described in FIG. 6 and/or FIG. 7 above.

The mobile terminal downloads the SCP_client software and installs the SCP_client software in the mobile terminal by connecting to the SCS_MSS of the central processing unit which performs the security channel forming function between the central processing unit and the mobile terminal (step, S1220). In this time, the concrete ways of downloading the SCP_client software and installing the SCP_client software in the mobile terminal is the same as described in FIG. 6, FIG. 7, and/or FIG. 10 above.

The mobile terminal connects to the SCS_ISS of the central processing unit which performs the personalization operation of the SCP_client software, and performs the SCP_client personalization (step, S1230). In this time, the concrete way of the SCP_client personalization is the same as described in FIG. 6, FIG. 7, and/or FIG. 10 above.

The mobile terminal checks the watching right by connecting to the SCS_PSS of the central processing unit through the ADE_agent (step, S1240). In this time, the way of checking the watching right is the same as described in FIG. 6, FIG. 7, and/or FIG. 11 above.

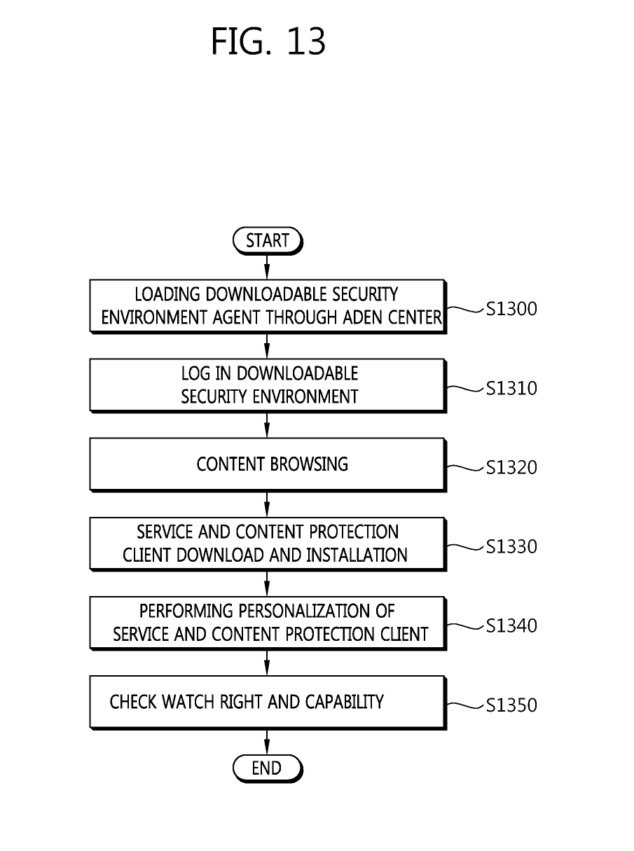

FIG. 13 is a flow chart of the content receiving method using the mobile terminal according to an embodiment of the present invention, which is the case that the ADEM apparatus exists.

Referring to FIG. 13, in case that the ADEM apparatus exists, the of the content receiving method using the mobile terminal connects to the ADE_MSS of the ADEM apparatus, and loads the ADE_agent through the ADEM apparatus (step, S1300). In this time the concrete way of loading the ADE_agent is the same as described in FIG. 7 above.

The ADE_agent of the mobile terminal connects to the SCS_PSS of the central processing unit, and performs the ADE log in (step, S1310). In this time, the concrete way of the ADE logging in is the same as described in FIG. 6 and/or FIG. 7 above.

The ADE_agent of the mobile terminal connects to the CP of the central processing unit, and performs the content browsing (step, S1320). In this time, the concrete way of the content browsing is the same as described in FIG. 6 and/or FIG. 7 above.

The mobile terminal downloads the SCP_client software and installs the SCP_client software in the mobile terminal by connecting to the SCS_MSS of the central processing unit which performs the security channel forming function between the central processing unit and the mobile terminal (step, S1330). In this time, the concrete ways of downloading the SCP_client software and installing the SCP_client software in the mobile terminal is the same as described in FIG. 6, FIG. 7, and/or FIG. 10 above.

The mobile terminal connects to the SCS_ISS of the central processing unit which performs the personalization operation of the SCP_client software, and performs the SCP_client personalization (step, S1340). In this time, the concrete way of the SCP_client personalization is the same as described in FIG. 6, FIG. 7, and/or FIG. 10 above.

The mobile terminal checks the watching right by connecting to the SCS_PSS of the central processing unit through the ADE_agent (step, S1350). In this time, the way of checking the watching right is the same as described in FIG. 6, FIG. 7, and/or FIG. 11 above.

The method according to the present invention described above can be embodied as computer readable codes on a computer readable recording medium. The computer readable recording medium is any data storage apparatus that can store data which can be thereafter read by a computer system. Examples of the computer readable recording medium include ROM, RAM, CD-ROMs, magnetic tapes, floppy discs, optical data storage apparatus, and carrier waves (such as data transmission through the internet).

The computer readable recording medium can also be distributed over network coupled computer systems so that the computer readable codes is stored and executed in a distributed manner. A functional program, code and code segments used to implement the present invention can be derived by a skilled computer programmer from the description of the invention contained herein.

While the present invention has been particularly shown and described by reference to exemplary embodiments thereof, it will be understood by those of ordinary skill in the art that various changes in form and details may be made therein without departing from the spirit and scope of the present invention as defined by the following claims, and the alternative embodiments should not be individually understood from the inventive concept and prospect of the present invention.

What is claimed is:

1. A method for receiving contents using a mobile terminal, comprising:
generating a security channel connected to a system being in charge of a service and content protection (SCP) client through an agent downloaded and installed in a mobile terminal;
downloading and installing one or multiple SCP client software of different kind from the system through the security channel generated by the agent; and
playing back the service or content provided in protected state by a content provider among the one or multiple SCP client software of different kind by driving the decodable SCP client software.

2. The method for receiving contents using a mobile terminal of claim 1, wherein the agent is an advanced downloadable security environment agent (ADE_agent), the SCP client is a service and content protection client (SCP_client), the system in charge of the service and content protection is a SCP client software policy sub-system (SCS_PSS), generating the security channel is performed by a SCP client software management sub-system (SCS_MSS).

3. The method for receiving contents using a mobile terminal of claim 1 further comprising:
setting up an initial value of the SCP client software installed in the mobile terminal by connecting to a system of the content provider and performing personalization of the SCP client software; and
identifying a watching right by connecting to the system in charge of the service and contents client protection of the content provider through the agent.

4. The method for receiving contents using a mobile terminal of claim 3, wherein the mobile terminal identifies the watching right is performed by identifying hardware capability, in identifying the watching right.

5. The method for receiving contents using a mobile terminal of claim 3, wherein identifying the watching right is performed by receiving a watching right confirmation response from the content provider through the agent.

6. The method for receiving contents using a mobile terminal of claim 5, wherein the watching right confirmation response is included in contents received from the content provider.

7. The method for receiving contents using a mobile terminal of claim 3, wherein setting up the initial value of the SCP client software installed and performing personalization of the SCP client software is performed by a SCP client software initialization personalization sub-system (SCS_ISS).

8. The method for receiving contents using a mobile terminal of claim 1, wherein the agent is installed in the mobile terminal beforehand by a mobile terminal manufacturer, in generating the security channel.

9. The method for receiving contents using a mobile terminal of claim 1, wherein the mobile terminal connects to the content provider, and downloads the SCP client software which is differentiated according to a user authority, in downloading and installing one or multiple SCP client software.

10. The method for receiving contents using a mobile terminal of claim 1 further comprising, if an apparatus for managing a security environment which is downloadable exists, loading the agent from the apparatus for managing a security environment which is downloadable by connecting to the system for managing the agent, and
wherein the agent loaded by loading the agent is used in generating the security channel.

11. The method for receiving contents using a mobile terminal of claim 10, wherein the apparatus for managing a security environment which is downloadable is an advanced downloadable security environment management (ADEM) apparatus, and the system for managing the agent is an advanced downloadable security environment management sub-system (ADE_MSS).

12. A method for managing downloadable security environment performed by an apparatus for managing downloadable security environment, comprising:
receiving a download request of an agent that provides downloadable security environment form a mobile terminal;
performing authorization of the mobile terminal using authorization identifier information which is included in the download request of the agent;
generating a security channel with the mobile terminal if the authorization identifier information matches as a result of performing the authorization of the mobile terminal; and
transmitting the agent to the mobile terminal using the security channel.

13. The method for managing downloadable security environment of claim 12, wherein the agent is an advanced downloadable security environment agent (ADE_agent), and wherein the apparatus for managing downloadable security environment is an advanced downloadable security environment management (ADEM) apparatus.

14. The method for managing downloadable security environment of claim 13, wherein the security channel provides message authorization for the agent, confidentiality and integrity, in generating the security channel.

15. The method for managing downloadable security environment of claim 12, wherein the download request of an agent comprises at least one of information of the mobile terminal, authorization identifier information of the mobile terminal and authorization key information of the mobile terminal, in receiving the download request of an agent.

16. An apparatus for managing downloadable security environment, the apparatus receiving a download request of an agent that provides downloadable security environment form a mobile terminal, performing authorization of the mobile terminal using authorization identifier information which is included in the download request of the agent, generating a security channel with the mobile terminal if the authorization identifier information matches as a result of performing the authorization of the mobile terminal, and transmitting the agent to the mobile terminal using the security channel.

17. The apparatus for managing downloadable security environment of claim 16, wherein the agent is an advanced downloadable security environment agent (ADE_agent), and wherein the apparatus for managing downloadable security environment is an advanced downloadable security environment management (ADEM) apparatus.

18. The apparatus for managing downloadable security environment of claim 16, wherein the security channel provides an application of the mobile terminal, downloadable message authorization for the agent, confidentiality and integrity.

19. The apparatus for managing downloadable security environment of claim 16, wherein the download request of an agent comprises at least one of information of the mobile terminal, authorization identifier information of the mobile terminal and authorization key information of the mobile terminal.
